(19) United States
(12) Patent Application Publication
(10) Pub. No.: US 2005/0274032 A1
(43) Pub. Date: Dec. 15, 2005

(54) Measurett N release

(76) Inventor: George Edwin Martin, Chisago City, MN (US)

Correspondence Address: George E. Martin, 10712 Green Lake Trail, Chisago City, MN, 55013, US

(21) Appl. No.: 10/634,493

(22) Filed: Aug. 6, 2003

Related U.S. Application Data
(60) Provisional application No. 60/402,646, filed on Sep. 16, 2002.

(51) Int. Cl. G01D 21/00

(52) U.S. Cl. 33/511

(57) ABSTRACT

1. A cradle used to measure the length of fish
2. Made of polymer-polyurethane— 3/16^{th} inch thick 3. 2 inch ruler in inches and centimeters 4. Has handle that allows user to slide fish back into water 5. Two sizes 20 inch & 30 inch in length a. 2½ in to 5 inch high b. 5 in to 6 in wide

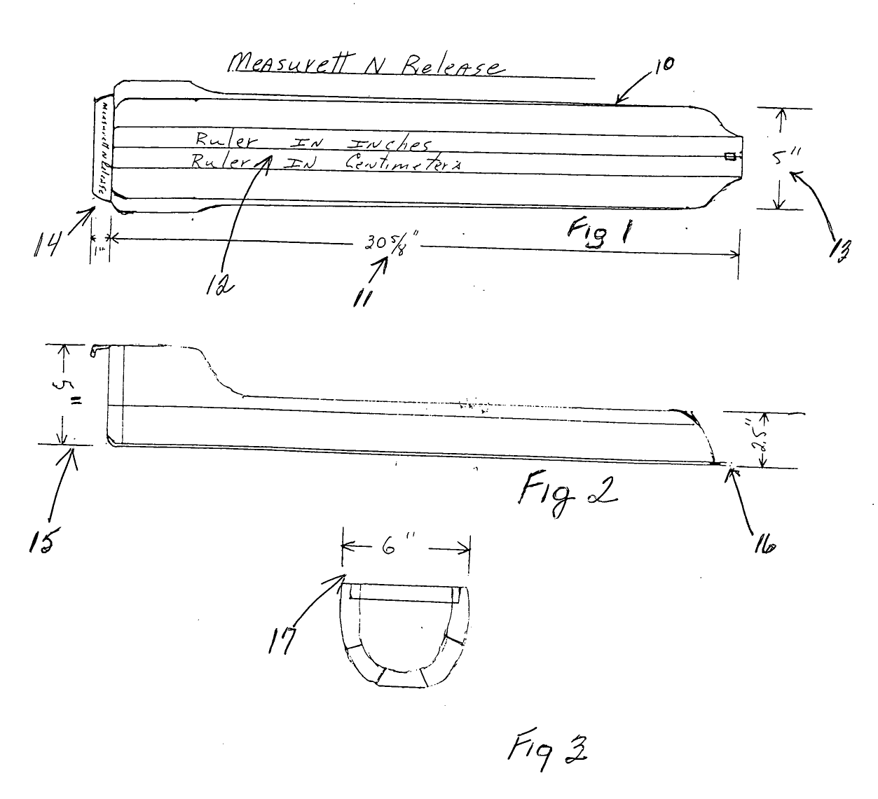

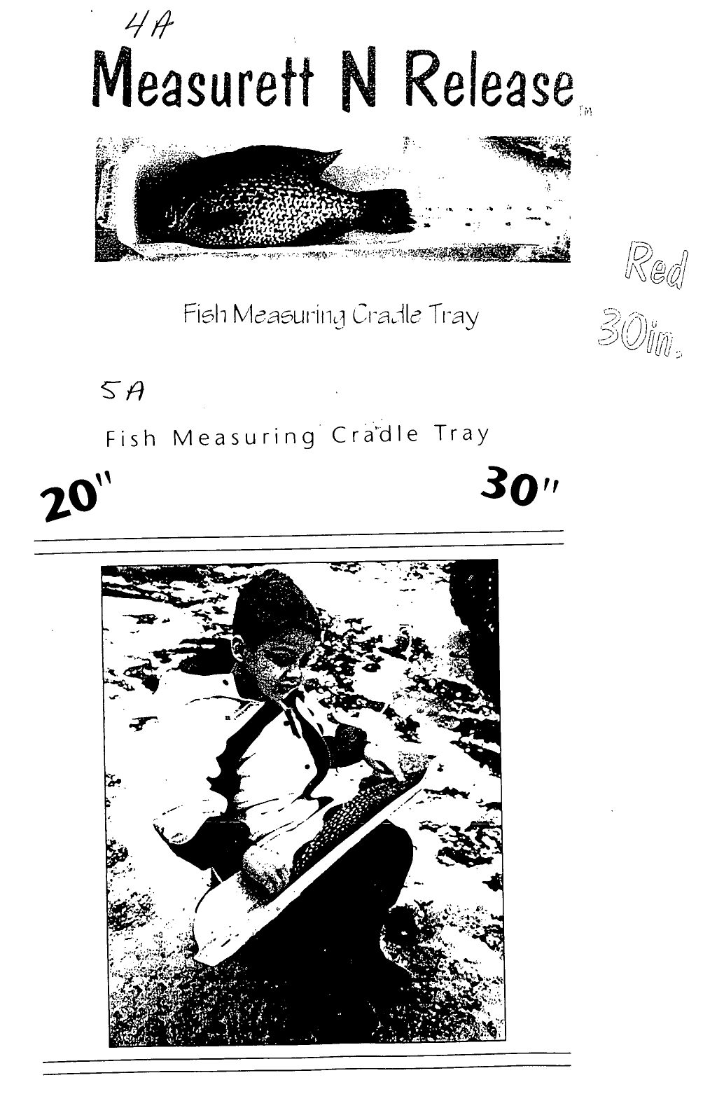

Measurett N Release is a cradle tray used to measure the length of fish in those states that have a slot size requirement.

Provisional patent application No. 60/402,646.

This invention came about from a fishing trip where the only thing we had to measure Our fish was a ruler on a cooler or a stick on paper ruler attached to the side of our boat. Both are hard to use which resulted in having an illegal size fish.

You lay fish in the cradle tray to measure its length and if you have to return the Fish to the water you just slide the tray into the water and the fish slides in which will Create less damage and stress to the fish. It's the most user friendly fish measuring device available.

It's made of one formed piece of polymer-polyurethane in lengths of 20⅝ inches And 30⅝ inches. The base has a 2 inch wide ruler in both inches and centimeters. The sides are 2½ to 5 inches high and 5 to 6 inches wide with a handle at one end.

1. A fish measuring device. An elongated base presenting a fish support surface with two sides and one end to form a cradle.

2. A fish measuring device according to claim has a handle at one end.

3. A fish measuring device according to claim has two rulers. One in inches and the other in centimeters.

4. A fish measuring device according to claim has sides that graduate from 2½ inches high to 5 inches high.

5. A fish measuring device according to claim that has a width of 5 inches to 6 inches wide.

6. A fish measuring device according to claim that has a length of 20 inches and 30 inches.

7. A fish measuring device according to claim that has a thickness of 3/16^{th}.

8. A fish measuring device according to claim that has a hollow body formed of a moldable polystyrene, polypropylene, butyrate and is environmentally safe.

9. A fish measuring device according to claim that can be purchased in a 20 inch length which is yellow in color or a 30 inch length which is red in color.
